(19) United States
(12) Patent Application Publication
(10) Pub. No.: US 2018/0281093 A1
(43) Pub. Date: Oct. 4, 2018

(54) SOLDER ADHESIVE FOR JOINING OF BATTERY TABS

(71) Applicant: GM GLOBAL TECHNOLOGY OPERATIONS LLC, Detroit, MI (US)

(72) Inventors: Hui-ping Wang, Troy, MI (US); Blair E. Carlson, Ann Arbor, MI (US); Ryan C. Sekol, Grosse Pointe Woods, MI (US)

(73) Assignee: GM GLOBAL TECHNOLOGY OPERATIONS LLC, Detroit, MI (US)

(21) Appl. No.: 15/475,726

(22) Filed: Mar. 31, 2017

(51) Int. Cl. B23K 1/00; H01M 2/20; H01M 2/30

(52) U.S. Cl. CPC B23K 1/0016; H01M 2/30; H01M 2/202

(57) ABSTRACT

A method of manufacturing a battery module includes applying an adhesive solder to a tab of a battery cell. The adhesive solder includes a mixture of an adhesive composition and a plurality of solder elements. The adhesive solder is compressed between the tab of the first battery cell and an electrically conductive element, such as a tab of a second battery cell or a bus plate. The adhesive solder is then heated, whereby the adhesive composition is cured to fixedly attach the tab of the first battery cell and the electrically conductive element together, and the plurality of solder elements bond with the tab of the first battery cell and the electrically conductive element to connect them in electrical communication.

### INTRODUCTION

The disclosure generally relates to a battery module, and a method of manufacturing the battery module.

Battery modules may be constructed from a plurality of individual battery cells layered one on-top-of another. Each of the battery cells includes at least one tab. The tab of each of the battery cells is fixedly attached and electrically connected to a tab on a second one of the plurality of battery cells, or alternatively, to a bus plate or a bus bar. For example, a tab of a first battery cell may be welded to a tab of a second battery cell. The weld provides both the mechanical and electrical connection therebetween.

### SUMMARY

A method of manufacturing a battery module is provided. The method includes applying an adhesive solder to a tab of a battery cell. The adhesive solder includes a mixture of an adhesive composition and a plurality of solder elements. The adhesive solder is compressed between the tab of the first battery cell and an electrically conductive element. The adhesive solder is then cured, whereby the tab of the first battery cell and the electrically conductive element are fixedly attached to each other by the adhesive composition, and the tab of the first battery cell and the electrically conductive element are electrically connected to each other by the plurality of solder elements.

In one aspect of the method of manufacturing the battery module, the tab of the first battery cell and the electrically conductive element are not welded together. Instead, the adhesive composition adheres them together forming the fixed connection therebetween, and the plurality of solder elements electrically connects them, providing the electrical connection therebetween.

In one embodiment of the method, the electrically conductive element includes at least one of a tab of a second battery cell or a bus plate.

In one aspect of the method of manufacturing the battery module, curing the adhesive solder includes heating the adhesive solder to a temperature equal to or less than a predetermined maximum temperature, for a time period equal to or less than a predefined maximum time period. In one embodiment, the predetermined maximum temperature is approximately two hundred degrees Celsius (200° C.). In another embodiment, the predetermined maximum temperature is approximately one hundred degrees Celsius (100° C.). In one embodiment of the method, the adhesive solder is heated with a heated clamp. In another embodiment of the method, the adhesive solder is heated with an electric induction process.

In one embodiment of the method of manufacturing the battery module, the plurality of solder elements include a low temperature solder having a melting temperature equal to or less than one hundred eighty degrees Celsius (180°). The predetermined maximum temperature is greater than the melting temperature of the plurality of solder elements, and is equal to or less than two hundred degrees Celsius (200° C.).

In one embodiment of the method of manufacturing the battery module, curing the adhesive solder is further defined as heating the adhesive solder while compressing the adhesive solder between the tab of the first battery cell and the electrically conductive element.

In another aspect of the method of manufacturing the battery module, the method includes cooling the adhesive solder after heating the adhesive solder to the temperature equal to or less than the predetermined maximum temperature, for the time period equal to or less than the predefined maximum time period. In one embodiment, cooling the adhesive solder is further defined as cooling the adhesive solder while maintaining the compression of the adhesive solder between the tab of the first battery cell and the electrically conductive element.

A battery module is also provided. The battery module includes a first battery cell having a tab, and an electrically conductive element. An adhesive solder interconnects the tab of the first battery cell and the electrically conductive element. The adhesive solder includes a mixture of an adhesive composition and a plurality of solder elements. The adhesive composition adheres the tab of the first battery cell and the electrically conductive element together to provide a secure bond therebetween. The plurality of solder elements connect the tab of the first battery cell and the electrically conductive element in electrical communication. In one embodiment of the battery module, the electrically conductive element includes a tab of a second battery cell. In another embodiment of the battery module, the electrically conductive element includes a bus plate.

Accordingly, the above described method uses the adhesive composition to form the structural bond that holds the tab of the first battery cell and the electrically conductive element together, and uses the plurality of solder elements to form the electrical connection between the tab of the first battery cell and the electrically conductive element.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic cross sectional view of a battery module in an unassembled state.

FIG. 2 is a schematic cross sectional view of the battery module in an assembled state, showing an adhesive solder being cured under pressure and with applied heat.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the FIGS., wherein like numerals indicate like parts throughout the several views, a battery module is generally shown at 20. The battery module 20 includes a plurality of battery cells 22, 24 connected together in electrical communication as is known in the art.

The exemplary embodiment of the battery module 20 shown in the figures and described herein includes a first battery cell 22 and a second battery cell 24. While the exemplary embodiment of the battery module 20 shows two battery cells 22, 24, it should be appreciated that the battery module 20 may include some other number of battery cells as is known in the art. The exemplary embodiment of the battery module 20 further includes a bus plate 26 attached to the second battery cell 24.

The first battery cell 22 includes a tab 28. The second battery cell 24 also includes a tab 30. The tab 28 of the first battery cell 22, the tab 30 of the second battery cell 24, and the bus plate 26 may be considered or described as electrically conductive elements, as they are connected to each other in electrical communication. For example, the tab 28 of the first battery cell 22, and the tab 30 of the second battery cell 24 may include and be manufactured from a Nickel coated Copper, Aluminum, or Copper. Similarly, the bus plate 26 may include and be manufactured from Copper or Aluminum. Furthermore, it should be appreciated that the tab 28 of the first battery cell 22, the tab 30 of the second battery cell 24, and the bus plate 26 may include and be manufactured from some other electrically conductive material not specifically described herein.

An adhesive solder 32 is disposed between and interconnects the tabs 28, 30 of the battery cells 22, 24 and an electrically conductive element, such as but not limited to the bus plate 26. As shown in the exemplary embodiment of the figures, the adhesive solder 32 is disposed between and interconnects the tab 28 of the first battery cell 22 and the tab 30 of the second battery cell 24. Additionally, the adhesive solder 32 is disposed between and interconnects the tab 30 of the second battery cell 24 and the bus plate 26.

The adhesive solder 32 includes a mixture of an adhesive composition 34 and a plurality of solder elements 36. The solder elements 36 may alternatively be referred to as solder balls. The adhesive composition 34 adheres the tab 28 of the first battery cell 22 and the electrically conductive element together to provide a secure bond therebetween. As used herein, the term “adhered”, “adhering” or “adhere” is defined as being permanently attached or fixed together, by a molecular force acting on an area of contact. The adhesive composition may include a substance or composition that is capable of securely bonding the two elements together, i.e., the tabs 28, 30 of the battery cells 22, 24 and/or the bus plate 26. The adhesive composition may be considered a glue or other similar substance. The specific type and chemical composition of the adhesive composition 34 will depend upon the specific materials used to form the tabs 28, 30 of the battery cells 22, 24 and/or the bus plate 26.

The solder elements 36 of the adhesive solder 32 connect the battery cells 22, 24 and/or the bus plate 26 in electrical communication. The solder elements 36 may include any soft metal used to join two harder metals together via melting and fusing to the parts of the joint, and that is of forming an electrical connection between the parts of the joint. The solder elements 36 may include a low temperature solder having a melting temperature equal to or less than one hundred eighty degrees Celsius (180°). Preferably, the low temperature solder of the solder elements 36 includes a melting temperature approximately equal to ninety degrees Celsius (90° C.). When melted, the solder elements 36 flow into engagement with and bond to the tabs 28, 30 of the battery cells 22, 24 and/or the bus plate 26. Upon cooling and re-solidifying, the solder elements 36 form an electrical connection between the elements joined together. For example, the solder elements 36 disposed between the tab 28 of the first battery cell 22 and the tab 30 of the second battery cell 24 join them in electrical communication, whereas the solder elements 36 disposed between the tab 30 of the second battery cell 24 and the bus plate 26 join the tab 30 of the second battery cell 24 and the bus plate 26 in electrical communication.

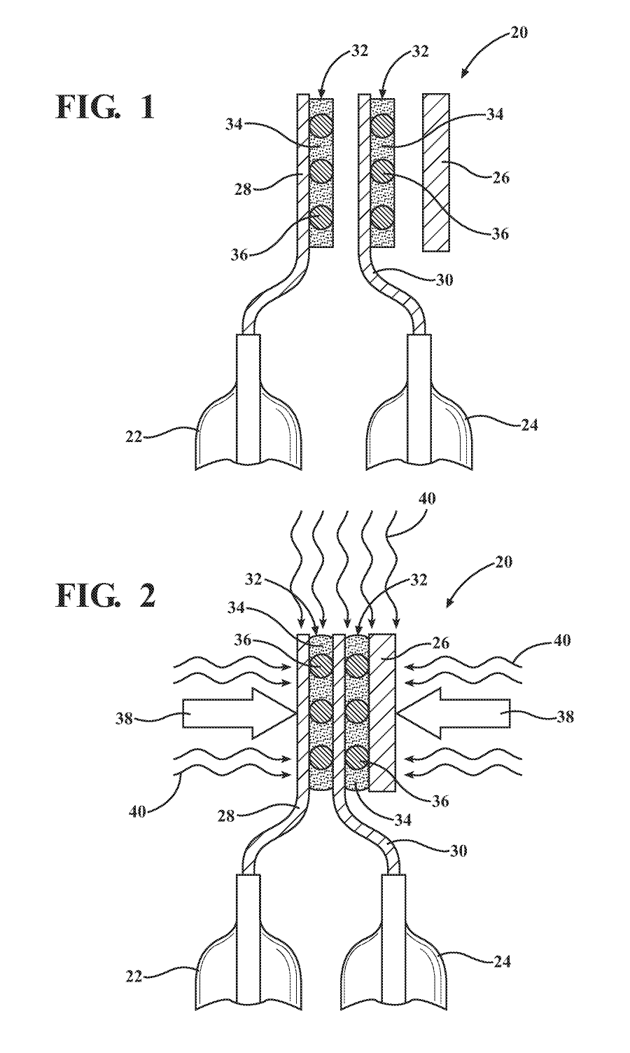

A method of manufacturing the battery module 20 is described herein. The method includes applying the adhesive solder 32 to a tab of a battery cell. In the exemplary embodiment shown in the figures, with reference to FIG. 1, the adhesive solder 32 is applied to one side of the tab 28 of the first battery cell 22, and is also applied to one side of the tab 30 of the second battery cell 24. The adhesive solder 32 may be applied in a suitable manner. For example, the adhesive solder 32 may be sprayed on, brushed on, deposited, etc.

Once the adhesive solder 32 has been applied to the tabs 28, 30 of the battery cells 22, 24, then the adhesive solder 32 is compressed between the tabs 28, 30 of the battery cells 22, 24 and/or the bus plate 26. A compressive force is generally indicated by arrows 38, shown in FIG. 2. The compressive force 38 used to compress the adhesive solder 32 may be applied in a suitable manner. The process requires a light compressive force 38 sufficient to ensure that the solder elements 36 contact the adjoining electrically conductive elements and the adhesive composition 34 is able to form a secure bond therebetween. It should be appreciated that excessive pressure or compression of the adhesive solder 32 may squeeze the adhesive solder 32 from the joint. The specific value of the compressive force 38 to be applied to compress the adhesive solder 32 is dependent upon the specific composition of the adhesives solder, and may be determined experimentally for each particular application.

Once the adhesive solder 32 is compressed between the electrically conductive elements to be joined together, then the adhesive solder 32 is cured. Curing the adhesive solder 32 causes the adhesive composition 34 to fixedly attach or adhere the tab 28 of the first battery cell 22 and the tab 30 of the second battery cell 24, as well as the tab 30 of the second battery cell 24 and the bus plate 26. Additionally, curing the adhesive solder 32 causes the solder elements 36 to bond with and electrically connect the tab 28 of the first battery cell 22 and the tab 30 of the second battery cell 24, as well as the tab 30 of the second battery cell 24 and the bus plate 26. The adhesive composition 34 is cured to adhere the tabs 28, 30 of the battery cells 22, 24 and/or the bus plate 26 together, and to melt the solder elements 36 so that they may bond to the tabs 28, 30 of the battery cells 22, 24 and/or bus plate 26 and connect them in electrical communication.

Curing the adhesive solder 32 includes heating the adhesive solder 32 to a temperature equal to or less than a predetermined maximum temperature, for a time period equal to or less than a predefined maximum time period. The added heat for heating the adhesive solder 32 is generally indicated by heat waves 40, shown in FIG. 2. More specifically, curing the adhesive solder 32 may be defined as heating the adhesive solder 32 while compressing the adhesive solder 32, such as between the tab 28 of the first battery cell 22 and another electrically conductive element.

The predetermined maximum temperature may be defined to equal a temperature that is less than the melting temperature of the material forming the tabs 28, 30 of the battery cells 22, 24 and/or the bus plate 26. Furthermore, the predetermined maximum temperature is greater than the melting temperature of the plurality of solder elements 36. In one exemplary embodiment, the melting temperature of the solder element is equal to or less than 180° C., and the predetermined maximum temperature is equal to or less than two hundred degrees Celsius (200° C.). In a preferred embodiment, the melting temperature of the solder elements 36 is approximately equal to 90° C., and the predetermined maximum temperature is approximately equal to one hundred degrees Celsius (100° C.). The predefined maximum time period will depend upon the predetermined maximum temperature and the melting temperature of the solder elements 36. Accordingly, the specific amount of time required may be determined experimentally for each application, in order to ensure that the adhesive composition 34 is completely cured, and that the solder elements 36 reach their melting temperature.

The adhesive solder 32 may be heated in a suitable manner. For example, the adhesive solder 32 may be heated with a heated clamp, which may also be used to compress the adhesive solder 32 between the tabs 28, 30 of the battery cells 22, 24 and the bus plate 26. Alternatively, an electric induction process may be used to heat the adhesive solder 32. It should be appreciated that the adhesive solder 32 may be heated in some other manner, whether described herein or not.

Notably, the tabs 28, 30 of the battery cells 22, 24 and/or the bus plate 26 are not welded together. As used herein, the term “welded” or “weld” is defined as the joining of two objects by heating both objects to their respective melting points to form a pool of molten material, mixing the molten material together, and allowing the molten material to re-solidify, thereby forming a homogeneous joint. Instead, the tabs 28, 30 of the battery cells 22, 24 and the bus plate 26 are adhered together by the adhesives composition. It is therefore the adhesive composition 34 that forms the structural bond between the tabs 28, 30 of the battery cells 22, 24 and/or the bus plate 26. Furthermore, the solder elements 36 do not form a welded joint, because the tabs 28, 30 of the battery cells 22, 24 and the bus plate 26 are not heated to their respective melting temperature. As such, the melted solder elements 36 cannot mix with the tabs 28, 30 of the battery cells 22, 24 and/or the bus plate 26. It is the solder elements 36 that are heated to their respective melting temperature so that they may flow against the elements to be joined and bonded thereto, i.e., the tabs 28, 30 of the battery cells 22, 24 and/or the bus plate 26.

After the adhesive solder 32 has been heated to a temperature that is equal to or less than the predetermined maximum temperature and greater than the melting temperature of the solder elements 36, then the adhesive solder 32 is cooled. Cooling the adhesive solder 32 solidifies the plurality of solder elements 36. The adhesive solder 32 may be cooled while maintaining the compression of the adhesive solder 32 between the tabs 28, 30 of the battery cells 22, 24 and/or the bus plate 26. Alternatively, the adhesive solder 32 may be cooled after removing the compressive force 38 that was applied to the battery module 20 to compress the adhesive solder 32 between the tabs 28, 30 of the battery cells 22, 24 and the bus plate 26.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of manufacturing a battery module, the method comprising:
applying an adhesive solder to a tab of a first battery cell, wherein the adhesive solder includes a mixture of an adhesive composition and a plurality of solder elements;
compressing the adhesive solder between the tab of the first battery cell and an electrically conductive element;
curing the adhesive solder, whereby the tab of the first battery cell and the electrically conductive element are fixedly attached to each other by the adhesive composition, and the tab of the first battery cell and the electrically conductive element are electrically connected to each other by the plurality of solder elements.

2. The method set forth in claim 1, wherein the tab of the first battery cell and the electrically conductive element are not welded together.

3. The method set forth in claim 1, wherein the electrically conductive element includes at least one of a tab of a second battery cell or a bus plate.

4. The method set forth in claim 1, wherein curing the adhesive solder includes heating the adhesive solder to a temperature equal to or less than a predetermined maximum temperature, for a time period equal to or less than a predefined maximum time period.

5. The method set forth in claim 4, wherein the predetermined maximum temperature is approximately two hundred degrees Celsius (200° C.).

6. The method set forth in claim 5, wherein the predetermined maximum temperature is approximately one hundred degrees Celsius (100° C.).

7. The method set forth in claim 4, wherein the plurality of solder elements include a low temperature solder having a melting temperature equal to or less than one hundred eighty degrees Celsius (180°), and wherein the predetermined maximum temperature is greater than the melting temperature of the plurality of solder elements, and equal to or less than two hundred degrees Celsius (200° C.).

8. The method set forth in claim 4, wherein heating the adhesive solder is further defined as heating the adhesive solder with a heated clamp.

9. The method set forth in claim 4, wherein heating the adhesive solder is further defined as heating the adhesive solder with an electric induction process.

10. The method set forth in claim 4, wherein curing the adhesive solder is further defined as heating the adhesive solder while compressing the adhesive solder between the tab of the first battery cell and the electrically conductive element.

11. The method set forth in claim 4, further comprising cooling the adhesive solder after heating the adhesive solder to the temperature equal to or less than the predetermined maximum temperature, for the time period equal to or less than the predefined maximum time period.

12. The method set forth in claim 11, wherein cooling the adhesive solder is further defined as cooling the adhesive solder while maintaining the compression of the adhesive solder between the tab of the first battery cell and the electrically conductive element.

13. A method of manufacturing a battery module, the method comprising:
applying an adhesive solder to a tab of a battery cell, wherein the adhesive solder includes a mixture of an adhesive composition and a plurality of solder elements;
compressing the adhesive solder between the tab of the first battery cell and an electrically conductive element;
heating the adhesive solder to a temperature equal to or less than a predetermined maximum temperature, for a time period equal to or less than a predefined maximum time period, such that the adhesive composition is cured to adhere the tab of the first battery cell and the electrically conductive element together, and such that the plurality of solder elements melt and bond the tab of the first battery cell and the electrically conductive element together in electrical communication; and
cooling the adhesive solder to solidify the plurality of solder elements.

14. The method set forth in claim 13, wherein the electrically conductive element includes at least one of a tab of a second battery cell or a bus plate.

15. The method set forth in claim 13, wherein the plurality of solder elements include a low temperature solder having a melting temperature equal to or less than one hundred eighty degrees Celsius (180°), and wherein the predetermined maximum temperature is greater than the melting temperature of the plurality of solder elements, and equal to or less than two hundred degrees Celsius (200° C.).

16. The method set forth in claim 13, wherein cooling the adhesive solder is further defined as cooling the adhesive solder while maintaining the compression of the adhesive solder between the tab of the first battery cell and the electrically conductive element.

17. The method set forth in claim 13, wherein heating the adhesive solder is further defined as heating the adhesive solder while compressing the adhesive solder between the tab of the first battery cell and the electrically conductive element.

18. A battery module comprising:
a first battery cell having a tab;
an electrically conductive element; and
an adhesive solder interconnecting the tab of the first battery cell and the electrically conductive element, wherein the adhesive solder includes a mixture of an adhesive composition and a plurality of solder elements, with the adhesive composition adhering the tab of the first battery cell and the electrically conductive element together to provide a secure bond therebetween, and with the plurality of solder elements connecting the tab of the first battery cell and the electrically conductive element in electrical communication.

19. The battery module set forth in claim 13, wherein the electrically conductive element includes a tab of a second battery cell.

20. The battery module set forth in claim 13, wherein the electrically conductive element includes a bus plate.
